(19) United States
(12) Patent Application Publication
(10) Pub. No.: US 2020/0356866 A1
(43) Pub. Date: Nov. 12, 2020

(54) OPERATIVE ENTERPRISE APPLICATION RECOMMENDATION GENERATED BY COGNITIVE SERVICES FROM UNSTRUCTURED REQUIREMENTS

(71) Applicant: International Business Machines Corporation, Armonk, CA (US)

(72) Inventors: Santanu Chakrabarty, Bangalore (IN); Pulkit Agarwal, Banaswadi (IN); Ajitha Chandran, KanyaKumari District (IN); Sivaraj Sethunamasivayam, BANGALORE (IN); SIVARANJANI KATHIRVEL, Dharapuram TK (IN)

(21) Appl. No.: 16/406,806

(22) Filed: May 8, 2019

(51) Int. Cl. G06N 5/02; G06N 3/08; G06F 16/35

(52) U.S. Cl. CPC G06N 5/02; G06F 16/35; G06N 3/08

(57) ABSTRACT

Methods and apparatus, including computer program products, implementing and using techniques for generating a recommendation for a composite computer application program from unstructured text. Unstructured text specifying functional requirements for a composite computer application program is received. The unstructured text is processed to generate topic metadata. The topics represent actions to be performed by the composite computer application program. Based on the generated topic metadata, a micro service is determined for performing each action. A recommendation for a sequence of microservices pertinent to the specified functional requirements is also determined, wherein each microservice is deployed in a separate container. Rules for synchronizing operations between the individual containers are specified. A recommendation for a deployable composite computer application program comprising the collection of individual containers and the specified rules is generated.

### BACKGROUND

The present invention relates to enterprise applications, and more specifically, to composite applications which are built from a combination of multiple existing functions using business sources of information.

A monolithic architecture is the traditional unified model for the design of a software program. “Monolithic” software is designed to be self-contained, that is, components of the program are interconnected and interdependent rather than loosely coupled as is the case with modular software programs. In a tightly-coupled architecture, each component and its associated components must be present in order for code to be executed or compiled, as all modules form a single executable unit, which is deployed on a web server or an application server. Furthermore, if any program component must be updated, the whole application has to be rewritten and redeployed, and therefore becomes complex to maintain.

In contrast, in a modular application, any separate module can be changed without affecting other parts of the program. Modular architectures reduce the risk that a change made within one element will create unanticipated changes within other elements, because modules are relatively independent. Modular programs also lend themselves to iterative processes more readily than monolithic programs.

These days, customers often express a desire to see working prototypes of their software applications as soon as possible. This has resulted in implementing so-called “Agile methodology” across the industry. Technological advancements (e.g., artificial intelligence, machine learning, etc.) have given rise to enhanced software development methodologies. Similarly, system development activities, such as software development, maintenance, operation activities have also become simpler and more efficient.

Recently, the concept of “composable infrastructure” has emerged as a novel way of approaching the deployment of larger software applications. In a composable infrastructure, compute, storage, and networking resources are abstracted from their physical locations, and can be managed by software, through a web-based interface. Composable infrastructure makes data center resources as readily available as cloud services, and is the foundation for private and hybrid cloud solutions. As resources are logically pooled, developers need not to physically configure hardware to support a specific software application.

In this framework, the developer instead defines the business requirements for physical infrastructure using policies and then the software uses application programming interface (API) calls to create (compose) the infrastructure it needs to run on bare metal, as a virtual machine (VM) or as a container. These applications are known as composite applications which are built from a combination of multiple existing functions using specified business sources of information.

### SUMMARY

According to one embodiment of the present invention, methods, systems and computer program products are provided for generating a recommendation for a composite computer application program from unstructured text. Unstructured text specifying functional requirements for a composite computer application program is received. The unstructured text is processed to generate topic metadata. The topics represent actions to be performed by the composite computer application program. Based on the generated topic metadata, a micro service is determined for performing each action. A recommendation for a sequence of microservices pertinent to the specified functional requirements is also determined, wherein each microservice is deployed in a separate container. Rules for synchronizing operations between the individual containers are specified. A recommendation for a deployable composite computer application program comprising the collection of individual containers and the specified rules is generated.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 shows a system 100 for generating an operative enterprise application, in accordance with one embodiment.

FIG. 2 is a flowchart showing a process for building an enterprise application from unstructured text, in accordance with one embodiment.

FIG. 3 shows an example of topic metadata, in accordance with one embodiment.

FIG. 4 shows an example list of URLs for a banking application, in accordance with one embodiment.

FIG. 5 shows an example of a user interface of an executable application, in accordance with one embodiment.

FIG. 6 shows a block diagram of a Kubernetes design for a banking application, in accordance with one embodiment.

FIG. 7 shows an example of a topic-based grid template, in accordance with one embodiment.

FIG. 8 shows an example of a template for a microservice documentation, in accordance with one embodiment.

FIG. 9 shows an example of a populated topic-based grid, in accordance with one embodiment.

FIG. 10 shows an example of a word gram, in accordance with one embodiment.

Like reference symbols in the various drawings indicate like elements.

### DETAILED DESCRIPTION

The various embodiments of the invention pertain to techniques for generating a recommendation for an operative enterprise application from unstructured requirements by cognitive services. In summary, an intelligent system analyzes unstructured text input by a user, which describes the features and requirements of an enterprise software application product. The system then generates a recommendation for a working enterprise software application, which includes composable applications, based on the analyzed text and a custom Docker/Kubernetes repository containing a wide range of containers with individual business functionalities. It should be noted that Docker/Kubernetes is merely one of several possible implementations, but as it is currently one of the most popular and widely available container platforms, it will be used by way of example in this specification. Even though most people having ordinary skill in the art are familiar with Docker/Kubernetes, a brief overview will now be presented in order to enhance the understanding for readers who may not be too familiar with these technologies.

Docker is a computer program that performs operating-system-level virtualization and is provided by Docker Inc. of San Francisco, Calif. As mentioned above, Docker is used to run software packages called containers. Containers are isolated from each other and bundle their own application, tools, libraries and configuration files, and they can communicate with each other through well-defined channels. All containers are run by a single operating-system kernel and are therefore more lightweight than virtual machines. Containers are created from images that specify the contents of the containers. The images are often created by combining and modifying standard images downloaded from public repositories. Docker includes a runtime application, the Docker Engine, which allows users to build and run containers, and also includes a service, Docker Hub, for storing and sharing images.

In order to coordinate and schedule the communication between the different containers and to address issues with scaling container instances, a number of solutions have emerged. Some of the more popular ones include Kubernetes, Mesos, and Docker Swarm. These solutions are some of the more popular options for providing an abstraction to make a cluster of machines behave like one big machine, which is vital in a large-scale environment.

Kubernetes is a container orchestrator that was originally developed at Google Inc. of Mountain View, Calif., and which has subsequently been donated to the Cloud Native Computing Foundation (CNCF) and is now available as open source. Kubernetes is a comprehensive system for automating deployment, scheduling and scaling of containerized applications, and supports many containerization tools, such as Docker. Kubernetes can be run on a public cloud service or on-premises, is highly modular, and open source. Kubernetes works around the concept of pods, which are scheduling units (and can contain one or more containers) in the Kubernetes ecosystem, and the pods are distributed among nodes to provide high availability.

In summary, Docker is a platform and tool for building, distributing, and running Docker containers, and Kubernetes is a container orchestration system for Docker containers. While Kubernetes and Docker are fundamentally different technologies, they work very well together, and both facilitate the management and deployment of containers in a distributed architecture.

The various embodiments described herein use cognitive technologies, such as Machine Learning approaches, Natural Language Processing, Convolutional Neural Network (CNN), and Recurring Neural Network (RNN) to analyze unstructured business requirements in a text format and generate recommendations for an enterprise application built on the composable infrastructure.

In some embodiments, the system also provides recommendations and/or pseudo code regarding the business functionalities, which can be integrated in the existing repository of Docker/Kubernetes, based on the various requirements that the system receives over time, to extend the offerings supported by the system.

A Microservices Architecture design is used to build complex applications by decomposing the business application into a set of smaller services, which are fast to develop, easy to understand and to maintain. Each microservice is a discrete standalone, and fully functional application, which is deployed in container managed by Docker. By deploying business functionalities as microservices in containers (which will act as discrete environments), the performance overhead can be reduced by deploying multiple microservices on the same server, since Docker containers require minimal resources.

Kubernetes schedules the containers and enables the communication among different containers, and thus functions as the container “orchestrator,” which also provides an abstraction to make a cluster of components behave like a large business application, which is vital in a large-scale environment.

As mentioned above, the system analyzes the unstructured business text describing the functionality of the proposed enterprise software product by using machine learning algorithms. It then generates the key business aspects from the text and matches them with already available Docker/Kubernetes repository to get the list of composable apps, microservices required to perform the operations corresponding to the specified business requirement. These operations will now be described in further detail and by way of example with reference to the drawings.

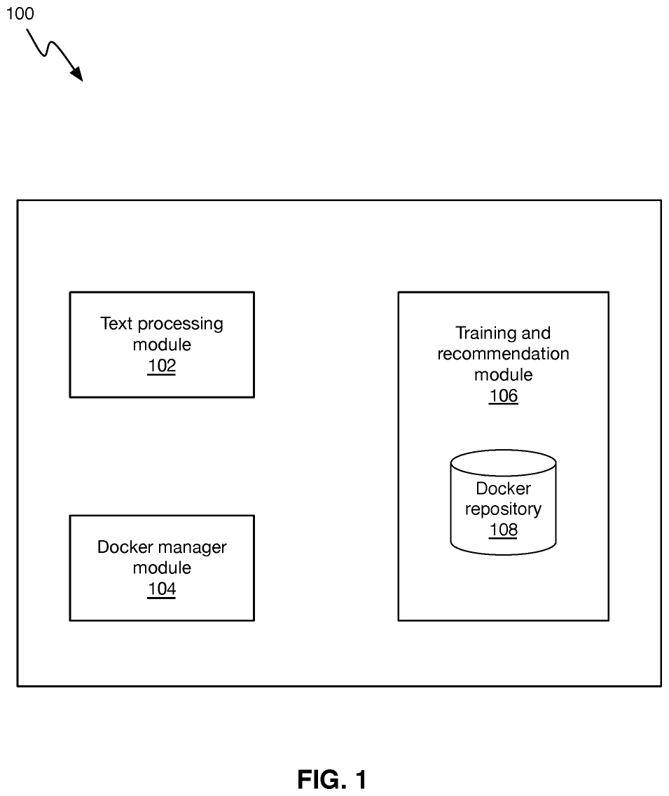

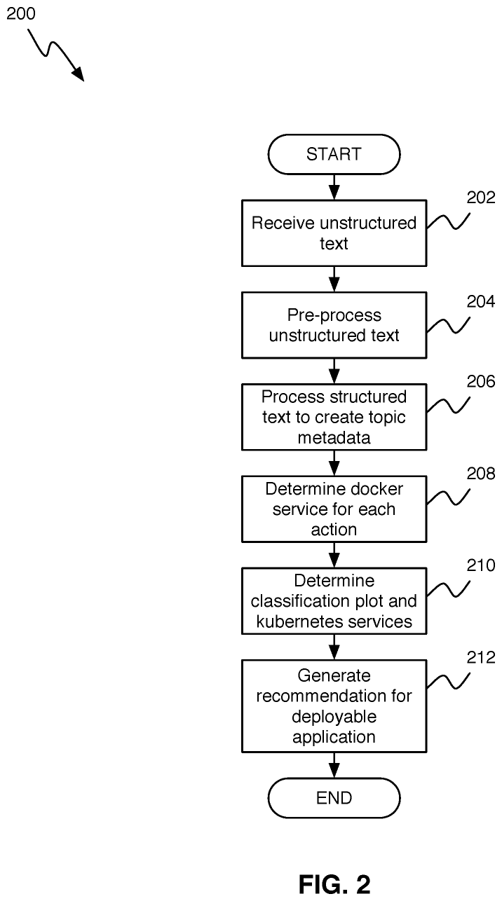

FIG. 1 shows a system 100 for generating an operative enterprise application, in accordance with one embodiment. As can be seen in FIG. 1, the system 100 includes a text processing module 102 for processing unstructured text data describing the requirements of the enterprise application. The system 100 further includes a docker manager module 104 for determining what Docker/Kubernetes components will be needed to create the executable application, and for assembling these components in such a way that an executable application is built. The system 100 further includes a training and recommendation module 106 containing pseudocode and a docker repository 108, which are both used by the docker manager module 104 when building the enterprise application. The operation of these modules and the interaction between them will now be described with reference to FIGS. 2-10.

FIG. 2 is a flowchart showing a process 200 for building an enterprise application from unstructured text, in accordance with one embodiment. As can be seen in FIG. 2, the process 200 starts by the text processing module 102 receiving unstructured text describing the requirements of the enterprise application, step 202. The unstructured text is typically input by a user. The following is an example of such unstructured text: “Set up an application for a customer or individual to perform banking operations like account management and associated services, such as fund transfer, international money transfer and having notifications around currency rates for a European region.”

Next, the text processing module 102 pre-processes the unstructured text, step 204. In this example, the pre-processing involves performing tokenization (i.e., segmenting the text into tokens, which may be, for example, individual words or phrases) and normalization (i.e., eliminating “noise” from the text and converting all the text into a consistent format for further processing). Both tokenization and normalization are well known concepts to those having ordinary skill in the art, and therefore no further explanation is deemed to be necessary here. Thus, the result of the preprocessing in step 204 is a structured version of the originally received unstructured text in step 202.

After pre-processing the text, the text processing module 102 processes the structured text, step 206, to create topic metadata. This processing involves using a Machine Learning (ML) system, and more specifically a combination of Latent Dirichlet Allocation (LDA) and Random Forest Classifier (RFC) algorithms, to extract topics from the text. Topics, as used herein, can refer to a single word or a phrase (i.e., a collection of words) derived from the unstructured input provided. It should, however, be noted that there are other ML systems that can perform the same tasks. The output from the LDA algorithm is processed by the RFC algorithm to create structured topic metadata. The topic metadata holds the key actions and the requirement change parameters.

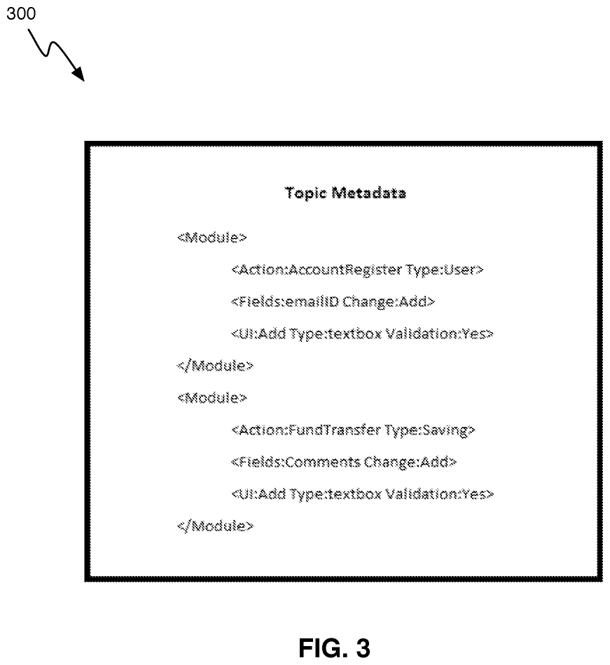

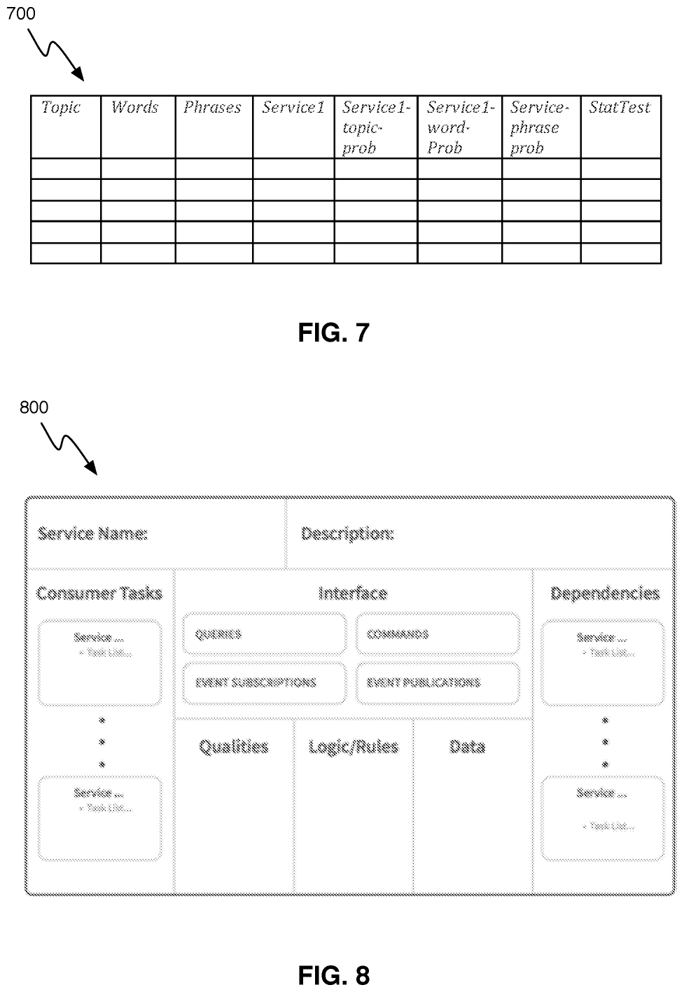

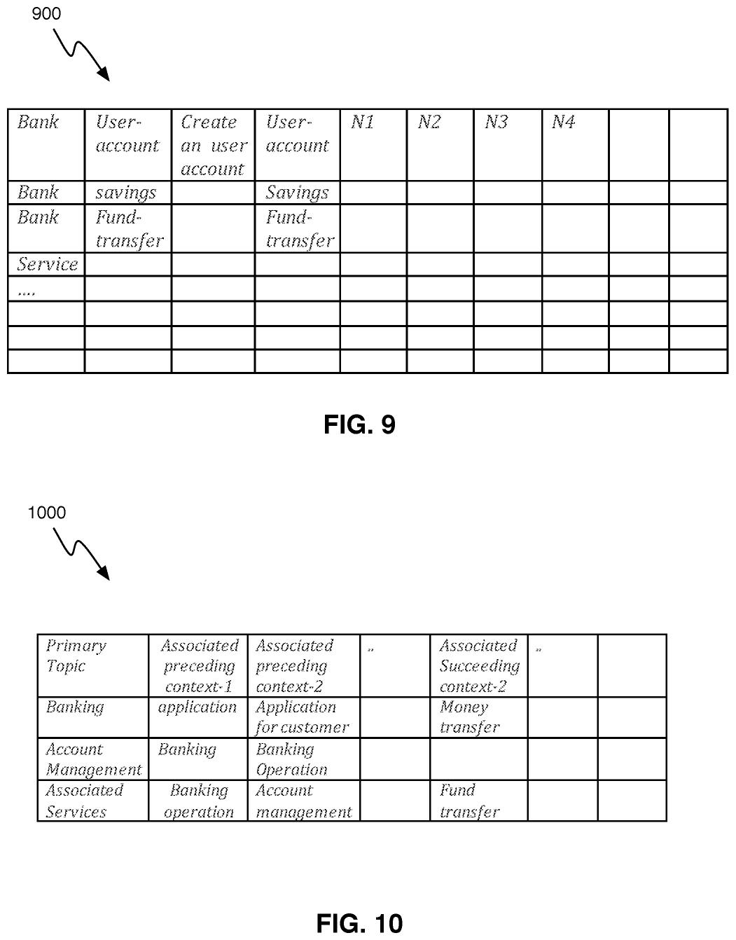

One example of topic metadata is shown in FIG. 3, which includes a module for an account registration action, and a module for a fund transfer action. The topic metadata is a mapping between the identified topics and words or phrases that are linked to the topic, and the matching micro services that can be invoked to realize that topic. The topic metadata in this embodiment is a grid-based representation of topics, the relevance of the topics derived as per the words present, the matching microservice(s) for the topic, and a system-derived score (numerical value) indicating how much mathematical relevance the construct holds. This will be described in further detail below with reference to FIGS. 7 and 9.

Next, a Natural Language Classification (NLC) system in the docker manager module 104 uses the identified topic metadata and the Kubernetes docker information (typically a list of all containers in all namespaces) to determine a suitable docker service to be invoked for each action module, step 208. In one implementation and as shown in FIG. 3, the topic metadata includes the service name, page actions, field details and so on. The NLC system uses a FindMatchingService Application Programming Interface (API) to find the closest matching class name/service name by a confidence factor.

The confidence factor is a numerical value derived from the probability of a match of a service against a specific topic. This includes the probability of a match and also the error factor for the mathematical model that is used to determine the probability score. The confidence factor takes into account other numerical values, such as topic taxonomy score, etc., which are derived from the count of phrases that are present within the set of unstructured input text provided as part of a training phase for the system.

Finally, in step 210, a classification plot with the highest confidence factor is determined among the topic and docker dataset, along with the appropriate Kubernetes services to be invoked in the identified sequences and bundled. In one implementation, the various types of business functionalities that are performed by the enterprise application and contained the dockers, are implemented using microservices. As is well known to those having ordinary skill in the art, microservices are a software development technique—a version of service-oriented architecture (SOA) architectural style—that structures an application as a collection of loosely coupled fine-grained services and lightweight protocols. The benefit of decomposing an application into different smaller services is that it improves modularity, which makes it very suitable in the context of various embodiments of this invention. A microservices-based architecture also enables continuous delivery and deployment, so that new services can be added to the docker repository 108, as needed.

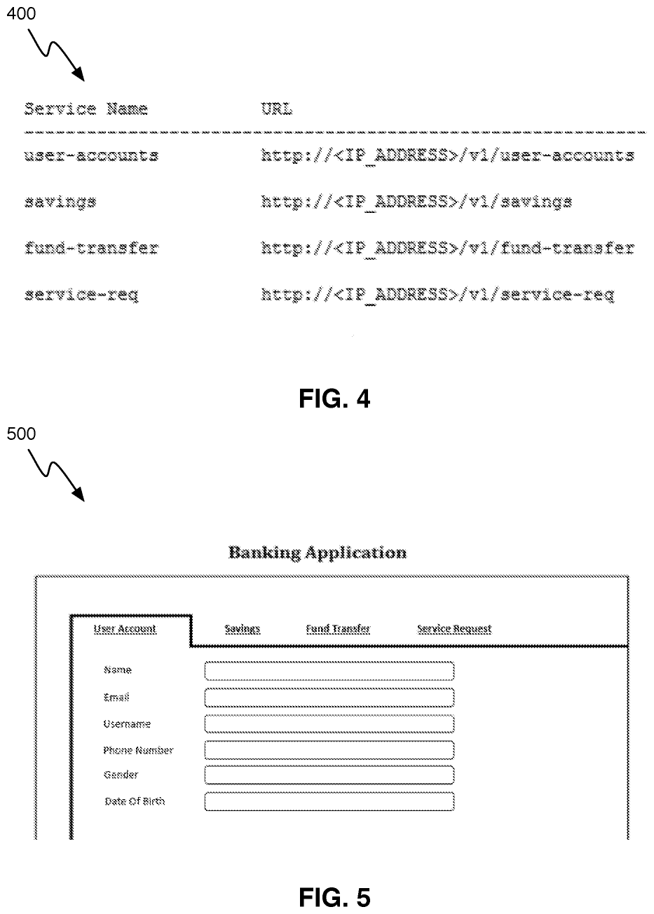

In one implementation, a GetUrlByServiceNames service takes the list of matching service names returned in FindMatchingService API as input, returns a list of corresponding URLs, and calls a GenerateDynamicApp service to generate recommendation for a deployable application, step 212. An example of a list of URLs for a banking application is shown in FIG. 4. The URLs in FIG. 4 contain links to microservices for “user accounts,” “savings,” “fund transfer” and “service requests.” A load balancer and Kubernetes HTTP Ingresses act as a gateway for the microservices and make the microservices available outside the cluster under an external IP address and through different paths. This results in a recommendation for an executable application, and the process 200 ends.

FIG. 5 shows an example of a user interface 500 of such an executable application, in accordance with one embodiment. As can be seen in FIG. 5, in this particular case, a banking application 500 contains a number of tabs, each corresponding to a particular function (User Account, Savings, Fund Transfer, Service Request) that can be performed by the executable application. Each tab corresponds to one of the URLs shown in FIG. 4, and thus hyperlinks to a microservice, when a user selects the tab.

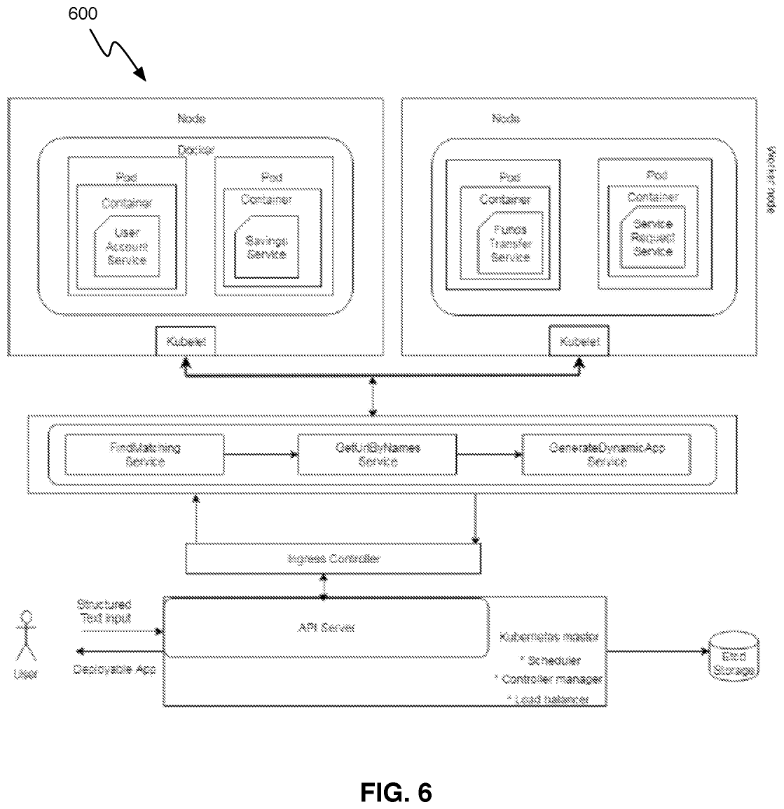

FIG. 6 shows a block diagram of a standard deployment of a microservice using the docker and Kubernetes design for a banking application, such as the one described above with reference to FIGS. 4 and 5. As can be seen in FIG. 6, the four services (i.e., user account service, savings service, funds transfer service, and service request service) are deployed. The blocks identified as “Node” are the two container instances, which hold the relevant microservices. The next layer is the API exposure endpoint, below which is the ingress controller-based master slave level node management. These are all standard approaches that are familiar to those having ordinary skill in the art, and are merely provided here as an alternative illustration further clarifying the concepts described above.

In some embodiments, a Missing Component Registry is maintained in an internal database to the system 100. For example, there may be instances where there is no microservice that corresponds to a particular user requirement. In such a situation, the unmatched service names can be combined with the provided user requirements and inserted into a registry service API that internally maintains a database. This database can be used, for example, to provide recommendations to developer or administrators to create new microservices having certain functionality, or to provide more fine-grained versions of existing microservices. How this is done in accordance with one embodiment will now be described.

In this embodiment NLP and text mining constructs are used to process unstructured text and to identify logically related patterns. The identified patterns are subsequently subjected to a Naive Bayes probability distribution approach to generate a numerical score that indicates the probability of the pattern being a close match. A topic-based n-gram approach is used along with LDA to identify the relevance of a single word or phrase from a document source. This is a combination of various natural language processing approaches, such as bi-gram analysis, tri-gram analysis, etc., which are well known to those having ordinary skill in the art.

As a prerequisite for this approach, the following unstructured document sources are needed:

1. Technical documentation for each microservice in a standard format.

2. User requirements.

3. Custom preference training data.

4. Custom selection rules.

These sources serve as the text source and training data for the system. The identification of missing microservices occurs in two phases. In the first phase, a topic-based grid is created for the registry of available microservices. In the second phase, the input provided by a user is subjected to NLP processing and text mining to identify the topics and associated phrases and words, and eventually to determine what topics lack matching microservices. Each of these phases will now be described.

As was mentioned, in Phase 1, a topic based grid is created for the registry of available microservices. A topic based grid, as used herein, is represented as an N×N matrix. The matrix contains information about topics that have been identified as a result of processing the API documentation for the available microservices. The matrix further contains information about how the phrases and words link with the topic and what services are aligned to the topics, and also the probability distribution for each service against the topic.

An example of a topic-based matrix 700 is shown in FIG. 7. As can be seen in FIG. 7, in the matrix 700, there is a column for Topics, which are logical groups derived from the unstructured text. There is a column for Words, which are words that are linked to the topic. There is a column for Phrases, which are phrases that are linked to the topic. There is a column for Microservices, which are microservices that are linked to the topic. There are columns for Probability Distributions for topics, words, and phrases, respectively, that indicate the probability of each service being linked to the topic. Finally, there is a column for Statistical Test Scores, that contains the error rate (chi-squared, for example.). It should be noted that this is merely one example, and that there may be matrixes in other embodiments that contain more or less information, depending on the specific implementation and the requirements at hand.

FIG. 8 shows an example of a template 800 for a microservice documentation from which information can be extracted to populate the matrix 700 of FIG. 7. Typically, each microservice AIP in the Missing Component Registry has a template 800. Text mining is used on the available microservices documents to divide them into natural groups that can be separately understood. Topic modeling is one method that allows unsupervised classification of such documents, similar to clustering on numerical data, and which detects natural groups of items, even when it is not known a priori what is being searched for. LDA is a particularly well suited method for fitting a topic model, as it treats each document as a mixture of topic and each topic as a mixture of words. This allows documents to “overlap” each other in terms of content, rather than being separated into discrete groups, in a way that mirrors typical use of natural language.

The topic-based grid is then updated with each user requirement from the user to improve the probability scores, as well as the related topic words and phrases. For example, assume that the registry contains N services, four of which are for a banking application. For example, there may be a “User-accounts” microservice for creating a bank user account, which is used for banking application creation purposes. There may be a “Savings” microservice for creating a savings account for an existing user, which links a savings feature to a user account. There may be a “Fund-transfer” microservice for adding a fund transfer feature, which links the fund transfer feature to a user savings account. Once the documentation for each of these services has been analyzed and processed using the topic-based n-gram approach described above, and been populated into the template 700 shown in FIG. 7, the resulting topic grid will look like the topic grid 900 shown in FIG. 9. This topic grid will be used as the source to which input requests are mapped and to identify the services required for accomplishing the desired functionality of the application.

In Phase 2, the input provided by the end user is subjected to NLP processing and text mining to identify the topics and associated phrases and words. The identified topics and phrases are matched against the available topic grid 900 of FIG. 9 to identify matching topics, phrases and words. The probability score along with the error rates are considered to identify the weights for the most appropriate match. The best matching topics are selected and any custom selection rules are given highest preference.

To continue the above example, assuming the input text reads “Set up an application for a customer or individual to perform banking operations like account management and associated services as, for example, fund transfer, international money transfer and having notifications around currency rate for a European region.” This input is processed using NLP with bi-gram, tri-gram and multi-gram processing to identify the topics, along with the preceding and succeeding context. The preceding and succeeding contexts are used to identify and rate the relevance of the topics. To do this, a combination of the frequency, order, repeating sequence etc. of n-gram based text processing is used to identify the probability of the occurrence of words/phrases and to rate the relevance of a topic and then the topic or words/phrases associated with the topic are matched to identify the sequence of relevant services.

For example, after the NLP stage, the output word n-grams can be as illustrated in FIG. 10. This grid 1000 leverages sophisticated RNN based error calculations to determine the error percentage signifying a cost function for predicting the topic rating and the probability distribution for the words/phrases. The topic vs. microservice matching is governed by this cost function and the resulting recommendation contains the dependent services with the probability distribution against each topic occurrence and error rate which is calculated by the causal feedback system to the grid which will refurbish the probability distribution.

The word grams are then compared against the topic grid to identify matching topics. This identification can be made by checking the primary topic match and using the associated preceding and succeeding contexts with the topic phrases and words present in the topic grid. A cumulative probability score factoring in the error percentage on match items provide a quantifiable value around the match and the sequence which can be obtained. Custom selection rules are applied to factor in individual preferences (system specific preferences).

After this identification, the recommended microservices that are available and can be used set up the application are published. Items that could not be matched against the available topics in the topic grid are marked as missing parameters, and are logged and reported back to the user for manual intervention. The manual intervention by the user may involve, for example, checking whether the mismatch was due to the topic grid not including the topic, due to there not being any service available, or due to the service being there but the topics could not be matched. In the latter case, there might be a way to refine or update the topic based n-gram algorithm implementation.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for generating a recommendation for a composite computer application program from unstructured text, comprising:
receiving unstructured text specifying functional requirements for a composite computer application program;
processing the unstructured text to generate topic metadata, wherein the topics represent actions to be performed by the composite computer application program;
based on the generated topic metadata, determining a micro service for performing each action and a recommendation for a sequence of microservices pertinent to the specified functional requirements, wherein each microservice is deployed in a separate container;
specifying rules for synchronizing operations between the individual containers; and
generating a recommendation for a deployable composite computer application program comprising the collection of individual containers and the specified rules.

2. The method of claim 1, wherein processing the unstructured text to generate topic metadata includes processing the unstructured text using one or more of:
Machine Learning, Natural Language Processing, Convolutional Neural Networks, and Recurring Neural Networks.

3. The method of claim 1, wherein processing the unstructured text to generate topic metadata includes:
pre-processing the unstructured text using one or more of tokenization and normalization to generate structured text token components corresponding to the unstructured text; and
processing the structured text token components to generate topic metadata.

4. The method of claim 3, wherein processing the structured text token components comprises:
processing the structured text token component using a combination of a Latent Dirichlet Allocation algorithm and a Random Forest Classifier algorithm; and
using a Recurring Neural Network-based context building approach to define a probability score for relevance a topic.

5. The method of claim 1, further comprising:
generating a recommendation for the deployment of the composite computer application program in a cloud environment.

6. The method of claim 1, wherein the deployable composite computer application program uses hyperlinks to access the microservices in the individual containers.

7. The method of claim 1, further comprising:
creating a database containing a missing component registry; and
adding an entry to the database in response to detecting that there is no existing microservice that corresponds to a specified user requirement.

8. A computer program product for generating a composite computer application program from unstructured text, the computer program product comprising a computer readable storage medium having program instructions embodied therewith, wherein the computer readable storage medium is not a transitory signal per se, the program instructions being executable by a processor to cause the processor to perform a method comprising:
generating a recommendation for a composite computer application program from unstructured text, comprising:
receiving unstructured text specifying functional requirements for a composite computer application program;
processing the unstructured text to generate topic metadata, wherein the topics represent actions to be performed by the composite computer application program;
based on the generated topic metadata, determining a micro service for performing each action and a recommendation for a sequence of microservices pertinent to the specified functional requirements, wherein each microservice is deployed in a separate container;
specifying rules for synchronizing operations between the individual containers; and
generating a recommendation for a deployable composite computer application program comprising the collection of individual containers and the specified rules.

9. The computer program product of claim 8, wherein processing the unstructured text to generate topic metadata includes processing the unstructured text using one or more of:
Machine Learning, Natural Language Processing, Convolutional Neural Networks, and Recurring Neural Networks.

10. The computer program product of claim 8, wherein processing the unstructured text to generate topic metadata includes:
pre-processing the unstructured text using one or more of tokenization and normalization to generate structured text token components corresponding to the unstructured text; and
processing the structured text token components to generate topic metadata.

11. The computer program product of claim 10, wherein processing the structured text token components comprises:
processing the structured text token component using a combination of a Latent Dirichlet Allocation algorithm and a Random Forest Classifier algorithm; and
using a Recurring Neural Network-based context building approach to define a probability score for relevance for a topic.

12. The computer program product of claim 8, further comprising instructions to:
generate a recommendation for the deployment of the composite computer application program in a cloud environment.

13. The computer program product of claim 8, wherein the deployable composite computer application program uses hyperlinks to access the microservices in the individual containers.

14. The computer program product of claim 8, further comprising instructions to:
create a database containing a missing component registry; and
add an entry to the database in response to detecting that there is no existing microservice that corresponds to a specified user requirement.

15. A system comprising:
a processor; and
a memory, wherein the memory comprises instructions that when executed by the processor causes the processor to perform a method comprising:
generating a recommendation for a composite computer application program from unstructured text, comprising:
receiving unstructured text specifying functional requirements for a composite computer application program;
processing the unstructured text to generate topic metadata, wherein the topics represent actions to be performed by the composite computer application program;
based on the generated topic metadata, determining a micro service for performing each action and a recommendation for a sequence of microservices pertinent to the specified functional requirements, wherein each microservice is deployed in a separate container;
specifying rules for synchronizing operations between the individual containers; and
generating a recommendation for a deployable composite computer application program comprising the collection of individual containers and the specified rules.

16. The system of claim 15, wherein processing the unstructured text to generate topic metadata includes processing the unstructured text using one or more of:
Machine Learning, Natural Language Processing, Convolutional Neural Networks, and Recurring Neural Networks.

17. The system of claim 15, wherein processing the unstructured text to generate topic metadata includes:
pre-processing the unstructured text using one or more of tokenization and normalization to generate structured text token components corresponding to the unstructured text; and
processing the structured text token components to generate topic metadata.

18. The system of claim 15, wherein processing the structured text token components comprises:
processing the structured text token component using a combination of a Latent Dirichlet Allocation algorithm and a Random Forest Classifier algorithm; and
using a Recurring Neural Network-based context building approach to define a probability score for relevance for a topic.

19. The system of claim 15, wherein the memory comprises instructions that when executed by the processor causes the processor to:
generate a recommendation for the deployment of the composite computer application program in a cloud environment.

20. The system of claim 15, wherein the deployable composite computer application program uses hyperlinks to access the microservices in the individual containers.
